(19) United States
(12) Patent Application Publication
(10) Pub. No.: US 2011/0317828 A1
(43) Pub. Date: Dec. 29, 2011

(54) APPARATUSES AND METHODS TO OBTAIN INFORMATION WITHOUT DISCLOSING THE INFORMATION TO AN AGENT AND WITHOUT RECORDING THE INFORMATION

(75) Inventor: Charles Corfield, Boulder, CO (US)

(73) Assignee: nVoq Incorporated, Boulder, CO (US)

(21) Appl. No.: 13/156,930

(22) Filed: Jun. 9, 2011

Related U.S. Application Data
(60) Provisional application No. 61/357,611, filed on Jun. 23, 2010.

(51) Int. Cl. H04M 3/00

(52) U.S. Cl. 379/265.02

(57) ABSTRACT

The technology of the present application provides a processor (a.k.a. a confidential processor) to obtain confidential information from a customer and to inhibit a customer service representative from receiving the confidential information. The processor obtains the information and converts it to a format to be input to an application that requires the information. The formatting may include providing a plug-in module at the application processor to cause the data field to be considered a password field to inhibit copying the information to the copy buffer or the like.

### CLAIM OF PRIORITY UNDER 35 U.S.C. §§119 AND 120

The present application claims priority to U.S. Provisional patent application Ser. Number 61/357,611, titled the same, and filed on Jun. 23, 2010, which application is incorporated herein by reference as if set out in full.

REFERENCE TO CO-PENDING APPLICATIONS FOR PATENT

None.

### BACKGROUND

1. Field

The technology of the present application relates generally to customer call centers, and more particular, to apparatuses and methods to obtain confidential information at the call center without disclosing the confidential information to the customer service agent and without recording the same in a quality assurance recording.

2. Background

Many businesses use customer call centers, whether virtual (e.g. home based agents) or brick and mortar, to service their customer base. Conventionally, a customer calls into the call center and a customer service representative (CSR or an operator) answers the call. The CSR often asks a series of questions and enters the information into a graphical user interface (GUI) located at the CSR's workstation for use by the customer relationship management application(s) (CRM application(s) or sometimes just referred to as application(s)). For example, the CSR may record a complaint or a service request where the CSR asks for information to be entered into particular data fields in the CRM.

Often the CSR must request confidential, sensitive, or protected information from a customer during a session. Such information may include credit card information, social security number information, personal information, information protected by Health Insurance Portability and Accountability Act (HIPAA), other types of health information, and the like. For example, a customer may call to purchase an item or service. Conventionally, the CSR will request information regarding payment. The CSR types the information into the CRM. Recent advancements in speech to text systems, such as are available from nVoq Incorporated, allow a CSR to speak the information that is converted by a speech to text engine to data that is automatically entered into particular fields in the CRM; see, for example, U.S. Pat. No. 7,702,093, issued Apr. 20, 2010, titled Systems and Methods to Redirect. Audio Between Callers and Voice Applications, the disclosure of which is incorporated herein as if set out in full.

As can be appreciated in these systems, however, the CRM's associated GUI allows the CSR to view and potentially copy, steal, or inadvertently disclose the confidential, sensitive, or protected information. Moreover, many call centers provide audio recordings of all customer call sessions that are reviewed by the agents for quality assurance. These audio recordings, to the extent they contain confidential, sensitive, and/or protected information, are subject to potentially rigorous standards to avoid inadvertent disclosure of the information. For example, audio recordings that record credit card information in the process of providing quality assurance recordings must be maintained under the Payment Card Industry Data Security Standards, sometimes referred to as PCI compliance.

Thus, against this background, it is desirable to develop improved apparatuses and methods to secure confidential, sensitive, and/or embarrassing information from customer service representatives and associated recordings.

### SUMMARY

To attain the advantages and in accordance with the purpose of the technology of the present application, a confidential processor is provided that is configured to receive a call transfer of a customer from the customer service representative or receive an audio stream from the customer. The confidential processor receives data from the customer, via either dual tone multi-frequency input, speech to text conversion, or the like, regarding confidential information of the customer. The confidential processor, optionally, may provide a status window to the customer service representative indicating the status of the gathering of the confidential information. The confidential processor is further configured to transfer the call or audio stream back to the customer service representative and provide the confidential information for the customer relationship management application. The data entered into the customer relationship management application is obfuscated. Obfuscation may include encryption of the data or setting the password attribute on the data field. For example, using the password field attribute, the display in the graphical user interface cannot be copied to the copy buffer, which prevents the CRM from pasting the data into an unobscured area.

In certain aspects, the technology of the present application pauses a quality assurance recording on transfer of the call or the audio stream to the confidential processor and while the confidential processor is processing the confidential information. The quality assurance recording is resumed when the confidential processor transfers the call or audio stream back to the customer service representative. Alternatively to pausing the quality assurance recording, the quality assurance recording may be provided a filler signal and/or simply record silence.

In certain aspects, the technology of the present application provides status information to the customer service representative while the confidential processor is receiving information from the user. The status updates may include information such as, call connected (or audio transferred), processing information, confirming information, repeating steps, customer alerts to indicate the customer is having difficulty.

In certain aspects, the technology of the present application may transfer the customer call or audio stream to a secure agent. A secure agent may be, for example, a supervisor, a background checked agent, or the like, considered more secure than the typical agent to which the initial call may be assigned.

The foregoing and other features, utilities and advantages of the invention will be apparent from the following more particular description of a preferred embodiment of the invention as illustrated in the accompanying drawings.

### BRIEF DESCRIPTION OF THE DRAWINGS

FIG. 1 is a functional block diagram of an exemplary system consistent with the technology of the present application;

FIG. 2 is a functional block diagram of a workstation consistent with the technology of the present application;

FIG. 3 is a functional block diagram of an exemplary system consistent with the technology of the present application;

FIG. 4 is a functional block diagram of an exemplary confidential processor consistent with the technology of the present application; and

FIG. 5 is a functional block diagram illustrative of a methodology consistent with the technology of the present application.

### DETAILED DESCRIPTION

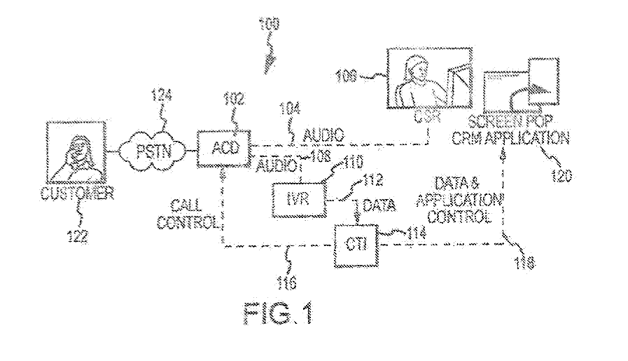

The technology of the present application will now be explained with reference to FIGS. 1-5. While the technology of the present application is described with relation to a customer call center, whether virtual, or brick and mortar, one of ordinary skill in the art will recognize on reading the disclosure that other configurations are possible. Moreover, the technology of the present application will be described with reference to particular discrete processors, modules, or parts, but one of ordinary skill in the art will recognize on reading the disclosure that processors may be integrated into a single processor or server or separated into multiple processors or servers. Moreover, the technology of the present application will be described generically and may be loaded onto a particular user's workstation (fat or thick client) or hosted by a server that is accessed by the workstation (thin client). Additionally, the technology of the present application is described with regard to certain exemplary embodiments. The word “exemplary” is used herein to mean “serving as an example, instance, or illustration.” Any embodiment described herein as “exemplary” is not necessarily to be construed as preferred or advantageous over other embodiments. All embodiments described herein should be considered exemplary unless otherwise stated.

Referring first to FIG. 1, a call center 100 is shown. A call center may comprise a centralized or dispersed number of workstations that receive and process data and information for a company. In the typical arrangement, call centers are typically associated with data and technology support for programs and applications. However, broadly, call centers may process orders for products or services, input of health related information, processing of flexible medical spending accounts, processing of insurance whether auto or health, and the like.

The call center 100 includes both voice or audio signals which lie on the signaling and audio path and terminate at the agent's phone (or headset) and data or IP-based signals that support the customer relationship management (CRM) application, whose graphical user interface (GUI) runs on the agent's processor, such as, for example, a personal computer or the like. As described above, the CRM and GUI may be hosted remotely from the workstation (thin client) or downloaded to the workstation (fat or thick client). Communication lines typically allow the transport of both audio and data signals.

Call center 100 includes devices, software modules, hardware components and wiring to support the various functions. For example, the call center 100 includes, an automatic call distribution (ACD) unit 102 having a communication connection 104 to an agent phone 106. ACD unit 102 also has a communication connection 108 to an interactive voice response (IVR) unit 110. Communication connections 104 and 108 may be overlapping, completely separate, or a combination thereof. As used herein, a communication connection, such as communication connection 104, can transmit one or more of audio and data signals over the connection. Also, while the communication connections shown herein are shown as physical connections via, for example, a cable or the like, it is possible for the communication connections to be wireless or wired. IVR 110 has a communication connection 112 to a computer telephony interface (CTI) 114. CTI 114 typically provides call control 116 to ACD 102 and data and application control 118 to an agent's computer 120. Thus, when a customer uses a telephone 122 or the like to call the call center over a conventional network 124, such as, the PSTN shown, the audio, data, and applications necessary for the agent to assist the caller are provided to the agent's workstation (including the agent's phone and/or headset).

While described as a conventional telephone call, call center 100 can receive conventional telephone calls using the Plain Old Telephone System (POTS) or using conventional cellular telephone calls. However, calls and audio should be understood to include conventional POTS and wireless telephone calls as well as the transfer of data using other networked based systems such as VoIP, audio streaming devices, and video devices such as video conferencing arrangements, SKYPE®, and the like.

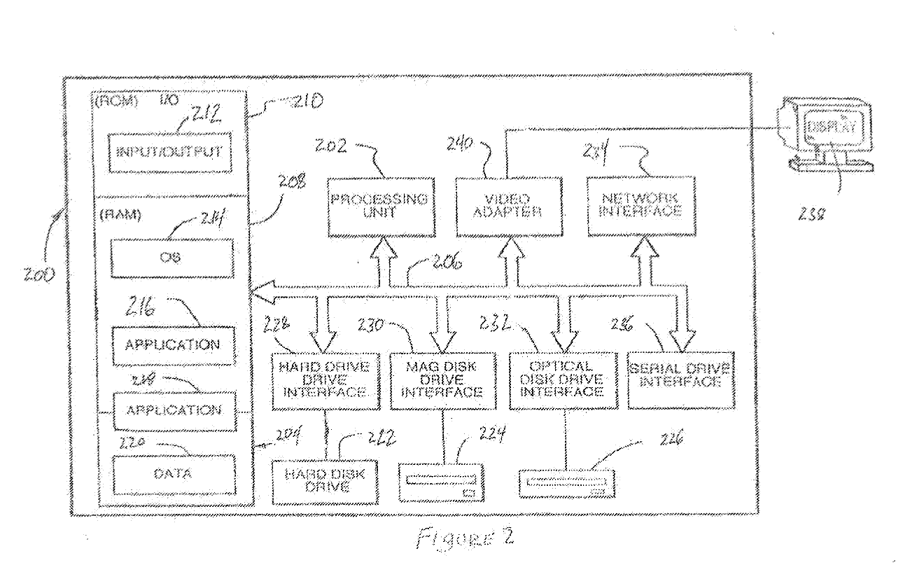

Referring now to FIG. 2, a functional block diagram of a typical workstation 200 for the technology of the present application. Workstation 200 is shown as a single, contained unit, such as, for example, a desktop, laptop, handheld, or mobile processor, but workstation 200 may comprise portions that are remote and connectable via network connection such as via a LAN, a WAN, a WLAN, a WiFi Network, Internet, or the like. Generally, workstation 200 includes a processor 202, a system memory 204, and a system bus 206. System bus 206 couples the various system components and allows data and control signals to be exchanged between the components. System bus 206 could operate on any number of conventional bus protocols. System memory 204 generally comprises both a random access memory (RAM) 208 and a read only memory (ROM) 210. ROM 210 generally stores a basic operating information system such as a basic input/output system (BIOS) 212. RAM 208 often contains the basic operating system (OS) 214, application software 216 and 218, and data 220. System memory 204 contains the code for executing the functions and processing the data as described herein to allow the present technology of the present application to function as described. Workstation 200 generally includes one or more of a hard disk drive 222 (which also includes flash drives, solid state drives, etc. as well as other volatile and non-volatile memory configurations), a magnetic disk drive 224, or an optical disk drive 226. The drives are connected to the bus 206 via a hard disk drive interface 228, a magnetic disk drive interface 230 and an optical disk drive interface 232. Application modules and data may be stored on a disk, such as, for example, a hard disk installed in the hard disk drive (not shown). Workstation 200 has network connection 234 to connect to a local area network (LAN), a wireless network, an Ethernet, the Internet, or the like, as well as one or more serial port interfaces 236 to connect to peripherals, such as a mouse, keyboard, modem, or printer. Workstation 200 also may have USB ports or wireless components, not shown. Workstation 200 typically has a display or monitor 238 connected to bus 206 through an appropriate interface, such as a video adapter 240. Monitor 238 may be used as an input mechanism using a touch screen, a light pen, or the like. On reading this disclosure, those of skill in the art will recognize that many of the components discussed as separate units may be combined into one unit and an individual unit may be split into several different units. Further, the various functions could be contained in one personal computer or spread over several networked personal computers. The identified components may be upgraded and replaced as associated technology improves and advances are made in computing technology.

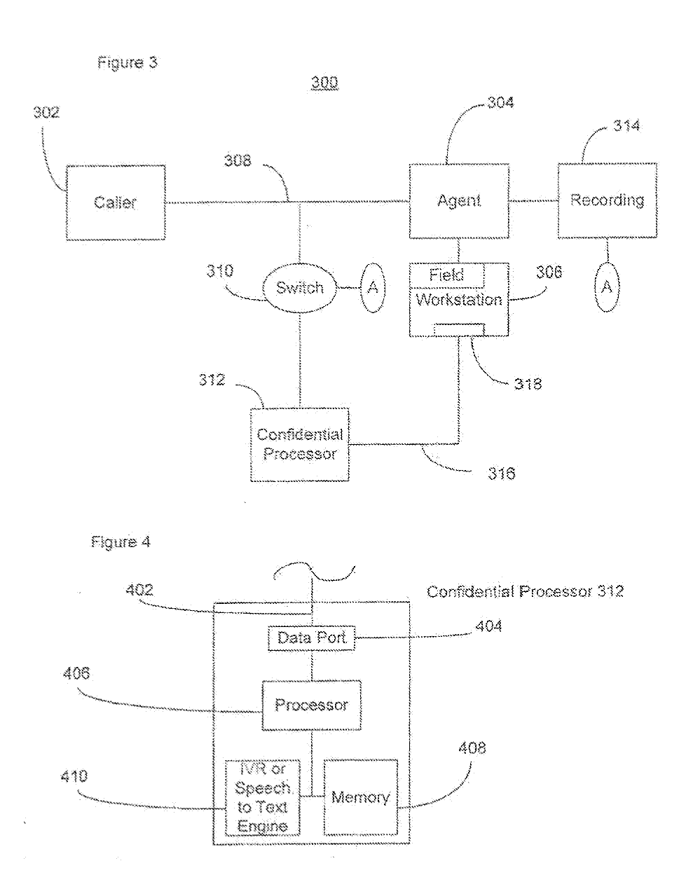

Referring now to FIG. 3, a simplified functional diagram of a call center 300 where a customer or caller 302 is connected to the CSR or agent 304. Caller 302 and agent 304 are connected via conventional telephones, cellular phones, voice over Internet protocol phones, computer phones, or the like. In this case, as the call is already connected, the ACD 102 and associated interfaces are not shown in the representation of FIG. 3. Agent 304 also has a workstation 200 of which a portion of the workstation monitor 306 is shown. Moreover, only a single field of the CRM is shown for exemplary purposes. While the technology of the present application is described with reference to a single display 306, two, three, or more displays or data fields in the CRM may use the technology described herein.

As shown, caller 302 is connected to CSR 304 via an audio and data connection 308. A switch 310 is provided to CSR 304. Switch 310 may be a software switch, clickable field or a physical switch, such as a flip switch, a rotating switch, or other similar toggle. Switch 310 is adapted to transfer the caller 302 (which may include transferring the call or the audio stream) to confidential processor 312. The physical act of transferring the call or audio stream from CSR 304 to confidential processor 312 may be accomplished using any known and conventional operations that are not explained herein as they are generally well known in the art.

As is generally known, quality assurance systems 314 often record the telephone call between caller 302 and agent 304. To the extent the recording contains confidential, sensitive, or protected information (sometimes referred herein as second type information; whereas, other information may be referred to as first type information), the recording must be maintained within certain parameters. For purposes of the present application, confidential (or second type) information may include any type of information that is to be withheld. Transferring the call to the confidential processor 312 inhibits quality assurance system 314 from recording the information and may reduce the security or maintenance requirements of the quality assurance system 314. As the call has been transferred, switch 310 optionally may send a signal to quality assurance or review audio recording system 314 to pause the recording while the call is transferred to confidential processor 312. As explained below, when confidential processor 312 returns to the call, a signal to resume recording is required in the event the recording was paused. In still other aspects, the technology may allow the recording to record silence and/or provide a filler audio, such as music, into the recording while the call transferred to or audio stream is directed to the confidential processor.

Confidential processor 312 is connected to the CRM application via a data connection 316. A data configuration module 318 may be used to ensure data entered into display 306 is not readable/accessible by the CSR 304. Data configuration module 318 may be, for example, a plug-in module to cause the data field in the CRM to equate the field as a password field or otherwise encrypt the data. Data in password fields are typically not viewable nor is the data in password fields able to be copied to the copy buffer. Alternatively, the CRM application may be configured such that display 306 is preconfigured to obscure the data displayed in the CRM field. As an additional measure of security, the entire data field may be displayed with the icon, typically a bullet star *, or the like. In one example, a credit card type may be requested. Thus, to inhibit guessing the credit card type, VISA may be represented by ****************, and MasterCard similarly would be represented by ****************, and American Express similarly would be represented by **************** to inhibit someone from guessing that **** is Visa, ********** is MasterCard, and **************** is American Express.

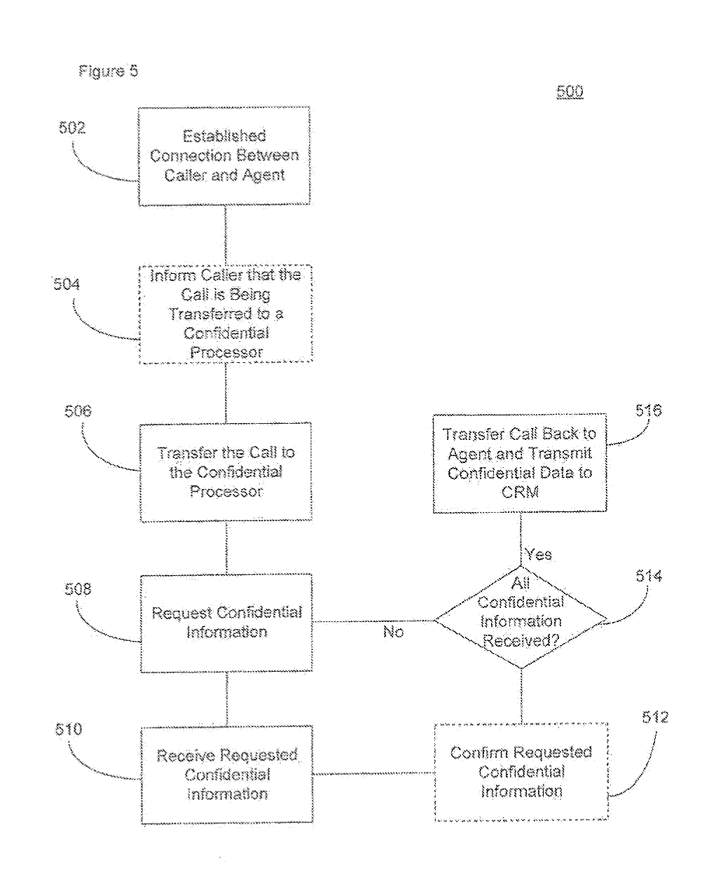

Referring now to FIG. 4, confidential processor 312 is shown in more detail. Confidential processor 312 has one or more input/output communication connections 402 connected to one or more data ports 404. Communication connections 402 may be configured to receive and transmit audio signals, data signals, or both including speech and DTMF signals. Data port 402 is connected to a processor 406. Processor 406 controls the major functions of the confidential processor 302 to allow it to function as further explained below. Processor 406 also processes various inputs and/or data received from and transmitted to data port 402 including audio signals and data signals. Processor 406 is connected to a memory 408. Memory 408 stores processing instructions to be executed by processor 406. The memory 408 also may store data necessary or convenient for operation of the confidential processor. Such data may include information usable by an interactive voice response unit or speech to text engine 410. IVR or speech to text engine receives input audio and or data signals and converts the audio and or data signals into data to populate particular fields in the CRM application. For example, the confidential processor may request a caller to input social security information (either spoken or DTMF) such that the confidential processor receives a spoken, for example, social security number consisting of an audio signal representative of 123-45-6789. The speech to text engine 410 would receive the audio signal and convert the audio signal to a data signal representative of 123456789 that is transmitted to the workstation for entry into the field.

Referring now to FIG. 5, a flowchart 500 is provided with an exemplary method of receiving information from a customer that is not displayed or recorded. While flowchart 500 is provided in certain discrete steps, one of ordinary skill in the art will recognize that the steps identified may be broken into multiple steps or multiple steps in the flowchart may be combined into a single step. Moreover, the sequence of events provided by the flowchart may be altered or rearranged without departing from the technology of the present application. With that in mind, flowchart 500 begins with a customer/caller 302 connected to an agent/CSR 304, step 502. The agent at some point during the call requires information from the caller that is confidential or sensitive. At this point, optionally, the caller is alerted that the call or audio is being transferred to a confidential processor to collect the information, step 504. The alert may be provided by the agent or automated. For example, on activation of switch 310, or on receipt of the transferred call or audio at confidential processor 312, an automated message may be transmitted to the caller indicating that the call or audio is or has been transferred to a confidential processor. The call or audio is transferred to the confidential processor 506. Whether alerted, confidential processor 312 provides a request to the caller regarding what type of information is requested, step 508. The request, in most instances, will be a pre-recorded audio signal indicating the input type and information requested. For example, the request may be for the caller to speak the name of the payment vehicle for the transaction. Payment information requested may include the credit card type, credit card number, security code, expiration date, etc. For personal information, the confidential processor may request date of birth, social security information, health concerns or the like. The confidential processor may function to accept dual tone multi-frequency (DTMF) input or include a speech recognition engine. Using DTFM input, for example, a person may enter credit card information indicating payment will be via a VISA card by dialing 8472 that would be equated with VISA. Alternatively, the caller may be presented with a number of choices, such as, for example, press 1 for MasterCard, 2 for Discover, etc. Once requested, the confidential processor would receive the requested confidential information, step 510. In still other aspects of the technology, the confidential processor 312 may connect to the keyboard of the caller's computer or cause a user interface to display on a monitor/display associated with the calling device, such as, for example, causing a keypad to display on a smartphone touch pad, etc. In still other aspects, the confidential processor may open a window in the caller's processing device, be it a desktop computer, a laptop computer, a smart phone, a cellular phone, a personal digital assistant, or the like. The window may operate similar to a chat window, an instant messaging window, or the like. The customer would enter the information in the popped window using any conventional data entering mode including, for example, a keyboard, a mouse, a touch screen, an optical pen, a speech to text engine, or the like. The data would be transferred to the confidential processor on the activation of, for example, a “send” key or the like. In still other aspects of the technology, the confidential processor may receive input using text messaging or other short messaging system protocols. Optionally, the confidential processor would confirm the information, step 512. Next, it would be determined whether all the confidential information required has been obtained, step 514. If all the required confidential information has been obtained, the caller is transferred back to the agent and the confidential data is transferred to the CRM, step 516. The caller is transferred by either transferring the call back to the CSR or directing the audio back to the CSR. The confidential data may be stored and transmitted when it is all collected or the confidential data may be transmitted on receipt or after confirmation. The confidential data may be transferred through the data configuration module 318 to make sure the confidential data is not displayed to the agent. Alternatively, the CRM may already be configured to receive data as confidential. If all the confidential information has not been received, control returns to step 508 and the confidential processor requests the next portion of confidential information. As mentioned above, if the audio recording for quality assurance was paused when the call was transferred, a resume signal may be sent to resume the recording. However, the recording, whether paused or not, did not record any of the confidential information as the call was transferred from the agent during the gathering of the confidential information.

As mentioned above, confidential processor 312 may supply data transmissions during the course of obtaining the confidential information from caller 302. Status of information may display in the GUI of the CRM or in a separate status display for obtaining the confidential information. For example, when switch 310 is activated, confidential processor 312 may transmit a signal to workstation 306 indicating that the call is being transferred, the call is connected, or the like. When the confidential processor is requesting confidential information, confidential processor 312 may transmit to workstation 306 information regarding the request, such as, for example:

Requesting the type of credit card to be used for payment;

Receiving information from the caller;

Confirming the type of credit card to be used for payment;

Requesting the credit card account number;

Receiving the credit card account number;

Confirming the credit card account number;

Requesting the credit card's security code;

Receiving the credit card's security code;

Confirming the security code;

Requesting the expiration date;

Receiving the expiration date;

Confirming the expiration date; and

etc.

Once the information is obtained, the confidential processor 312 would transmit an update to the workstation 306 that the caller is being transferred back to the agent.

If the confidential processor does not receive certain information, such as the type of credit card to be used for payment after the first query, the confidential processor may query the request to the caller again. The status update may update to provide indicia that the information is being requested again. For example, after two requests the confidential processor may transmit a trouble indicia such that the display at workstation 306 shows the status of the call in a different color, such as RED, or such that the status indicator flashes, etc. Moreover, the request may time out if no information is received. If after a predefined number of unsuccessful attempts, or after a certain amount of time with no input, the confidential processor may transfer the call back to the agent 304. Alternatively, the agent 304 may activate switch 310 at any point during the process to force the confidential processor to transfer the call back to the agent 304. Still alternatively, the confidential processor may transfer the call to a supervisor or confidential information cleared agent such that the information may be recorded in a secure fashion.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. The above identified components and modules may be superseded by new technologies as advancements to computer technology continue.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. An apparatus for receiving confidential information comprising:
a customer service station comprising at least one processor configured to receive a communication link from a caller where the communication link comprises at least an audio stream from a caller, the customer service station executing an application to record information from the call;
at least one switch connected to the processor configured to transfer the communication link from the caller to a confidential processor and to return the call to the customer service station; and
the at least one processor configured to receive from the confidential processor data corresponding to confidential information and input the confidential information to the application wherein the confidential information is obfuscated from a customer service representative.

2. The apparatus according to claim 1 further comprising a data configuration module that obfuscates the data prior to inputting the information to the application.

3. The apparatus according to claim 1 wherein the data is obfuscated by configuring the data as password data.

4. The apparatus according to claim 1 wherein the data is obfuscated by encrypting the data.

5. The apparatus according to claim 1 further comprising a connection to a quality assurance recording device that records audio between the caller and the customer service representative wherein the switch is configured to disable the quality assurance recording while the call is transferred to the confidential processor.

6. The apparatus according to claim 5 wherein the switch disables the quality assurance recording by at least one of turning the recording off or providing a substitute recording.

7. The apparatus according to claim 5 wherein the switch is configured to restart the quality assurance recording device when the call is transferred back from the confidential processor.

8. A method performed on at least one processor comprising the steps of:
establishing a communication link between a customer service representative and a customer to receive a first type of information;
determining a need to obtain a second type of information from the customer by the customer service representative;
transferring the communication link to a confidential processor to obtain the second type of information from the customer without providing the information to the customer service representative;
obtaining the second type of information from the customer; and
transferring the communication link from the confidential processor back to customer service representative along with the second type of information such that the second type of information is not determinable by the customer service representative, wherein the second type of information is obtainable without the customer service representative being able to determine the second type of information.

9. The method of claim 8 further comprising:
receiving information from the customer at the confidential processor that at least comprises the second type of information; and
formatting the information received at the confidential processor into a format usable by the customer service representative without allowing the customer service representative to obtain the information.

10. The method of claim 9 wherein the step of formatting includes converting the information to password format.

11. The method of claim 9 wherein the step of formatting includes encrypting the information.

12. The method of claim 8 further comprising populating an editable field in a graphical user interface with the second type of information.

13. The method of claim 8 further comprising:
monitoring the communication link between the customer and the customer service representative;
discontinuing the monitoring when the communication link is transferred to the confidential processor; and
reactivating the monitoring when the communication link is transferred back to the customer service representative.

14. The method of claim 13 wherein the step of monitoring comprises recording.

15. The method of claim 14 wherein the step of discontinuing comprises at least one of stopping the recording or providing a filler for recording.

16. The method of claim 8 further comprising updating the customer service representative on a progress of the confidential processor in obtaining the second type of information.

17. A confidential processor for use in providing confidential information to an application, the confidential processor comprising:
a port configured to receive a transfer from a customer service representative of a call between a customer and a customer service representative;
a processor coupled to the port and configured to receive data in a first format from the customer relating to the confidential information and to transmit data in a second format to an application accessible by the customer service representative;
a memory coupled to the processor; and
a format engine coupled to the processor, the format engine configured to receive the data in a first format from the customer and convert the data into a second format to be transmitted by the processor.

18. The confidential processor of claim 17 wherein the format engine is a speech to text engine.

19. The confidential processor of claim 17 wherein the format engine is an interactive voice response unit.

20. The confidential processor of claim 17 further comprising an obfuscation engine configured to provide the data in a second format that prevents the customer service representative from deciphering the data.
